(19) United States
(12) Patent Application Publication
(10) Pub. No.: US 2012/0087793 A1
(43) Pub. Date: Apr. 12, 2012

(54) Multi purpose variable speed wind powered generator

(76) Inventor: John Michael McDuffie, Marco Island, FL (US)

(21) Appl. No.: 12/925,019

(22) Filed: Oct. 12, 2010

(51) Int. Cl. F03D 3/06

(52) U.S. Cl. 416/44

(57) ABSTRACT

A Multi Purpose Variable Speed Wind Powered Generator is configured to generate electrical power to all types of transportation and equipment in any wind condition. An on board trip computer monitors wind speed and calibrates settings. As wind speed increases in certain increments the wind speed activates the variable pitch modulation, which controls the blades angle of attack controlling rotor rpm. As the wind speed increases substantially wind speed activates the variable pitch modulation in the rotors decreasing pitch to keep rpm relative. At extreme wind speeds rotor pitch modulation adjusts almost to a neutral position to keep rotor rpm relative. Then the onboard trip computer responds in like sequence in union with wind monitor and rotors partially closing the grill diaphragm disk. This allows less airflow through the grill diaphragm disk to the rotors. Rotor modulation returns back to original pitch positioning and the processes are repeated as needed through every wind speed. Any transmission drive type can be used to engage propulsion forces from the electric motor. Rotor brakes are to slow or stop rotors movement at any time for any reason. The combustion engine is used at any time or any reason.

### BACKGROUND OF INVENTION

1. Field of Invention

The present invention relates to a wind generator more practically, to a multi purpose variable speed wind powered generator designed to power all forms of transportation and equipment in all wind speeds.

2. Description of the Related Art

The wind-powered generator is used to generate electrical current for use in all transportation and equipment. The transportation can be initially powered using a combustible engine, a pre-charged battery, or the transportation can be faced into a head wind. Prevailing winds push against the rotors generating power to charge batteries. Once batteries are charged, the transportation or equipment unit can be moved under its own electrical power. As it moves forward, the wind speed turns the rotors, generating ample electrical power to charge batteries, accelerate, and power luxury equipment. An on board trip computer monitors wind speed and calibrates settings. As wind speed increases in certain increments the wind speed activates the variable pitch modulation, which controls the blades angle of attack controlling rotor rpm. As the wind speed increases substantially the wind speed activates the variable pitch modulation in the rotors decreasing pitch to keep rpm relative. At extreme wind speeds rotor pitch modulation adjusts almost to a neutral position to keep rotor rpm relative. The onboard trip computer responds in like sequence in union with wind monitor and rotors partially closing the grill diaphragm disk. This allows less airflow through the grill diaphragm disk to the rotors. Rotor modulation returns back to original pitch positioning and the processes are repeated as needed through every wind speed. Any transmission drive type can be used to engage propulsion forces from the electric motor. Rotor brakes are to slow or stop rotors movement at any time for any reason.

### SUMMARY OF THE INVENTION

The present invention has been accomplished under the circumstances in view. The countries need to brake free from foreign oil companies grasps. It is one object of the present invention to start this process. The Multi Purpose Variable Speed Wind Powered Generator will get the winds of change blowing in this direction. This invention introduces a new concept for a very old idea, while avoiding limitations with prior applications of wind-powered generation.

An on board trip computer monitors wind speed and calibrates settings. As wind speed increases in certain increments the wind speed activates the variable pitch modulation, which controls the blades angle of attack controlling rotor rpm. As the wind speed increases substantially the wind speed activates the variable pitch modulation in the rotors decreasing pitch to keep rpm relative. At extreme wind speeds rotor pitch modulation adjusts almost to a neutral position to keep rotor rpm relative. The onboard trip computer responds in like sequence in union with wind monitor and rotors partially closing the grill diaphragm disk. This allows less airflow through the grill diaphragm disk to the rotors. Rotor modulation returns back to original pitch positioning and the processes are repeated as needed through every wind speed. Any transmission drive type can be used to engage propulsion forces from the electric motor. Rotor brakes are to slow or stop rotors movement at any time for any reason.

To achieve this and other objectives of the present invention, the multi purpose variable speed wind generator comprises an automobile chassis for a base frame. The wind blows through the grill diaphragm disk turning the rotors, generating ample electrical power to charge batteries, accelerate, and power luxury equipment. The on board trip computer monitors wind speed, calibrates rotor and diaphragm disk modulation. As wind speed increases in certain increments the wind speed activates the variable pitch modulation, which controls the blades angle of attack controlling rotor rpm. At extreme wind speeds rotor pitch modulation adjusts almost to a neutral position to keep rotor rpm relative. The onboard trip computer responds in like sequence in union with wind monitor and rotors partially closing the grill diaphragm disk. This allows less airflow to pass through the grill diaphragm disk to the rotors. Rotor modulation returns back to the original pitch and the processes are repeated as needed through every wind speed. Any transmission drive type can be used to engage propulsion forces from the electric motor. Rotor brakes are to slow or stop rotors movement at any time for any reason.

### BRIEF DESCRIPTION OF DRAWINGS

FIG. 1 is a top view of the present invention.

### DETAILED DESCRIPTION OF THE DRAWINGS

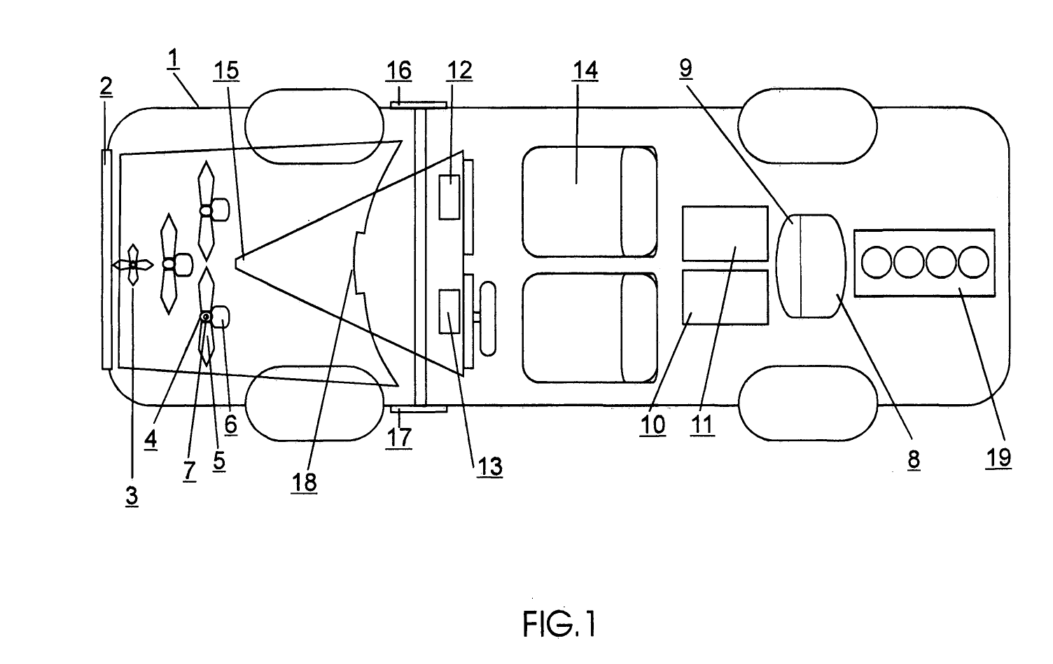

Referring to FIG. 1 of the Multi Purpose Variable Speed Wind Powered Generator in accordance with the present invention is shown comprising an automobile chassis for a base frame 1. The wind blows through the grill diaphragm disk 2, hitting wind speed monitored 3. Rotors spin 4, pitch of the blade is changed 5, and 6 generates electric current. Rotor brake 7 stops or slows rotor for any reason, and electric motor is used for thrust 8. Transmissions drive 9 engages propulsion forces, main batteries 10 are charged, as well as the auxiliary batteries 11. Onboard trip computer 12 keeps system in sink. Instrument panel 13 is for interior lighting of gauges, and luxury equipment. Passenger compartment is for seating and storage 14. Center wind diversion 15 is elongated for storage; right fender wind diversion vent 16, and left fender wind diversion vent 17, as well as, hood diversion vent 18 enhance airflow. The combustion engine 19, is used as needed for any reason

Particular embodiments of the invention have been described in some detail for the purpose of illustration; however, the invention is not limited to the embodiments of a car or a rotor blade described above. On the contrary, the invention extends to any variant that produces the above described essentials characteristics by any equivalent means. The grill diaphragm disk portion of this invention can also be used with fixed or flexed pitched rotors.

The invention claim is:

1. The Multi Purpose Variable Speed Wind Powered Generator is designed to power all forms of transportation and equipment in all wind speeds. An on board trip computer monitors wind speed and calibrates settings. As wind speed increases in certain increments the wind speed activates the variable pitch modulation, which controls the blades angle of attack controlling rotor rpm. As the wind speed increases substantially wind speed activates the variable pitch modulation in the rotors decreasing pitch to keep rpm relative. At extreme wind speeds rotor pitch modulation adjusts almost to a neutral position to keep rotor rpm relative. The onboard trip computer responds in like sequence in union with wind monitor and rotors partially closing the grill diaphragm disk. This allows less airflow through the grill diaphragm disk to the rotors. Rotor modulation returns back to original pitch positioning and the processes are repeated as needed through every wind speed. Any transmission drive type can be used to engage propulsion forces from the electric motor. Rotor brakes are to slow or stop rotors movement at any time for any reason. The combustion engine is used as needed for any reason.
